(19) United States
(12) Patent Application Publication
(10) Pub. No.: US 2026/0270449 A1
(43) Pub. Date: Sep. 10, 2026

(54) VIDEO CODING SYSTEM AND METHOD

(71) Applicant: Sony Interactive Entertainment Inc., Tokyo (JP)

(72) Inventor: Philip Cockram, London (GB)

(73) Assignee: Sony Interactive Entertainment Inc., Tokyo (JP)

(21) Appl. No.: 19/559,173

(22) Filed: Mar. 6, 2026

(30) Foreign Application Priority Data
Mar. 7, 2025 (GB) 2503328.3

(51) Int. Cl. H04N 19/172; H04N 19/132; H04N 19/167

(52) U.S. Cl. CPC H04N 19/172; H04N 19/132; H04N 19/167

(57) ABSTRACT

A system for encoding video content, the system comprising an image frame obtaining unit configured to obtain one or more image frames from a content source, a colour sampling unit configured to sample a plurality of pixels within an obtained image frame in accordance with a predetermined pattern, wherein the predetermined pattern indicates a bit depth at which the colour of each of the pixels is to be sampled, wherein the colour sampling unit is configured to reduce the bit depth of at least a subset of the pixels within the obtained image frame, and an encoding unit configured to encode the one or more image frames that have been subjected to the colour sampling.

### CROSS-REFERENCE TO RELATED APPLICATIONS

The present application claims the benefit of and priority to GB Patent Application 2503328.3, filed Mar. 7, 2025, and titled “VIDEO CODING SYSTEM AND METHOD”, the contents of which is incorporated herein by reference in its entirety for all purposes.

### BACKGROUND OF THE INVENTION

### Field of the Invention

This disclosure relates to a video coding system and method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

In recent years there has been a growing demand for video content having a higher quality; this includes both pre-generated content, such as television programmes and movies, and content being rendered in real-time such as video games. This is often reflected in demands for higher resolution, higher frame rates, or improved colour reproduction, for example.

While such content can be made available, difficulties may arise in the distribution of that content-retaining the original level of quality can mean that file sizes or required streaming bandwidths become larger than is practical for distribution via a network. This can be due to limitations on a client's internet speeds, for example, or a significant burden being placed upon a content distribution server. It is therefore desirable that improvements to the quality of video content are provided without introducing a significant data overhead.

In view of this, improvements to the efficiency of encoding image frames are considered to be advantageous as this can enable high-quality video content to be transmitted in a reduced-size data package or in a stream with a lower bandwidth requirement.

It is in the context of the above discussion that the present disclosure arises.

### SUMMARY OF THE INVENTION

Various aspects and features of the present invention are defined in the appended claims and within the text of the accompanying description.

Some embodiments include a method for encoding video content including obtaining one or more image frames from a content source; sampling a plurality of pixels within an obtained image frame in accordance with a predetermined pattern, where the predetermined pattern indicates a bit depth at which the color of each of the pixels is to be sampled, wherein the color sampling reduces the bit depth of at least a subset of the pixels within the obtained image frame; and encoding the one or more image frames that have been subjected to the color sampling.

In some embodiments, the predetermined pattern is a checkerboard pattern.

In some embodiments, the predetermined pattern varies between different frames of the one or more frames.

In some embodiments, sampling the plurality of pixels comprises sampling each of the pixels within an image frame to a reduced bit depth, wherein the reduced bit depth is different for different pixels in accordance with the predetermined pattern.

In some embodiments, the predetermined pattern comprises a first region and a second region each corresponding to a plurality of pixels, the first region indicating a higher average bit depth per pixel than the second region, wherein the first region is identified in dependence upon a predicted or measured viewer gaze direction for the corresponding image frame.

In some embodiments, the one or more image frames comprise Wide Colour Gamut pixels, and wherein sampling the plurality of pixels comprises sampling the Wide Colour Gamut pixels to generate Standard Dynamic Range pixels.

In some embodiments, sampling the plurality of pixels comprises performing a tonemapping process as a part of the sampling.

In some embodiments, the method further includes: obtaining information about one or more of the image frames, wherein the information comprises one or more of edge information, lighting information, content information, and/or one or more colour histograms; and encoding the information with the image frames.

Some embodiments include a method for decoding video content including receiving image frames encoded by the method for encoding video content; decoding the received image frames to obtain one or more decoded image frames; interpolating pixels in the one or more decoded image frames which have a reduced bit depth, wherein the interpolation generates colour values having an increased bit depth for those pixels; and outputting one or more image frames that have been subjected to the interpolation process.

In some embodiments, interpolating pixels comprises using one or more preceding or following image frames in a sequence to perform interpolation for a given image frame.

In some embodiments, interpolating pixels comprises performing an inverse tonemapping process before interpolating pixel colour values.

Some embodiments include a system that includes: one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment system;

FIG. 2 schematically illustrates an exemplary checkerboard pattern;

FIG. 3 schematically illustrates a method which utilises a colour sampling scheme in line with the discussion of FIG. 2;

FIG. 4 schematically illustrates a checkerboard pattern for interpolation;

FIG. 5 schematically illustrates a system for encoding video content;

FIG. 6 schematically illustrates a system for decoding video content;

FIG. 7 schematically illustrates a method for encoding video content; and

FIG. 8 schematically illustrates a method for decoding video content.

### DESCRIPTION OF THE EMBODIMENTS

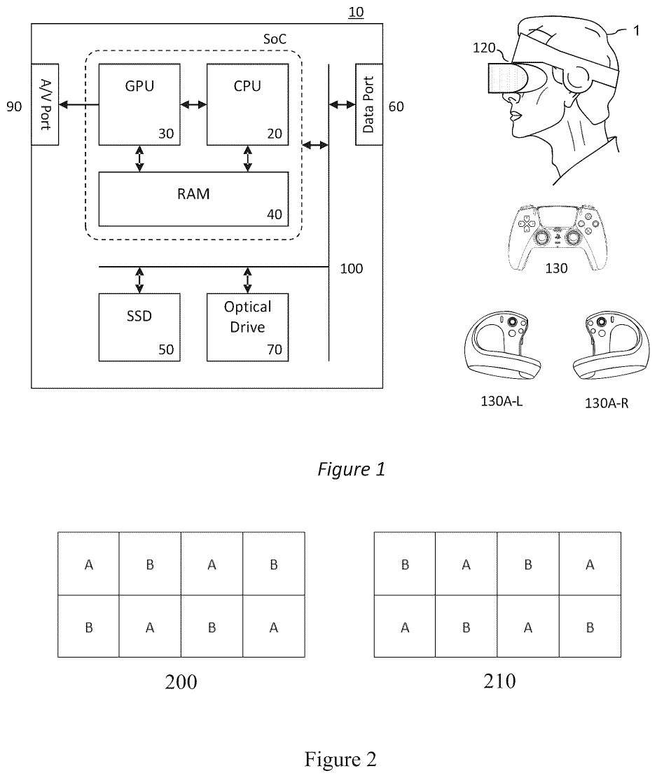

Referring now to the drawings, wherein like reference numerals designate identical or corresponding parts throughout the several views, embodiments of the present disclosure are described. Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

The entertainment system 10 of FIG. 1 is an example of a device that may be configured to encode video content for transmission to another device for display; alternatively, or in addition, the entertainment system 10 may receive video content that it is configured to decode and display to a user.

The present disclosure relates to a more efficient approach to video coding. Improvements to the efficiency are obtained by sampling colour information for each pixel in accordance with a checkerboard (or other) pattern in which the colour of different pixels are sampled with different bit depths. This is performed so as to reduce the data size of each encoded image frame (and therefore the encoded video as a whole). While sampling colours with a greater bit depth can lead to a more accurate reproduction of an image, this can lead to a significant increase in the amount of data required to encode an image frame- and as such it is advantageous to be able to achieve this benefit in an efficient manner.

FIG. 2 schematically illustrates an exemplary checkerboard pattern which may be used for sampling pixel colours in respective image frames. Reference 200 corresponds to a pattern for a first image frame, while reference 210 corresponds to a pattern for a second image frame. Each of the boxes represents data for a particular pixel in the image frame, with the ‘A’ pixels being encoded using a first colour gamut and the ‘B’ pixels being encoded using a second colour gamut. Only eight pixels are shown for each image frame for conciseness—it would of course be understood that this approach may be adopted for any image size and/or aspect ratio.

The first and second colour gamuts are different, in that one is larger than the other (that is, one is able to represent a greater number of colours than the other). For instance, the ‘A’ pixel may be encoded using a standard dynamic range (SDR) format which typically uses eight bits per colour component whilst the ‘B’ pixels are encoded using a high dynamic range (HDR) format or a wide colour gamut (WCG) format which may use ten, twelve, or sixteen (for example) bits per colour component. The specific formats used to encode the colour information may be selected freely, with the only requirement being that one format has a greater bit-depth than the other.

This manner of sampling the colours of pixels in respective image frames is advantageous in that the amount of data required is reduced—for instance, using 8- and 16-bits to represent the colours in alternating pixels can reduce the data requirements by half. By alternating the checkerboard pattern in consecutive frames, it can be ensured that the colour information for a given pixel is provided at the greater bit depth on a regular basis. While the dynamic checkerboard pattern may be considered advantageous, it is not necessary as it is considered that the use of a static checkerboard pattern would also provide good results in respect of the picture quality during display.

While shown here as a checkerboard pattern, it is considered that any other suitable pattern may be used in which a pixel having a smaller bit depth is at least partially surrounded by pixels having a greater bit depth. For instance, alternating columns or rows may be preferred to a checkerboard pattern, or squares of nine pixels in which the central pixel has a different bit depth to the other eight pixels. It is also considered that the ratio of pixels having each bit depth is not required to be 1:1; patterns which deviate from this ratio may also be considered appropriate. Having fewer high bit depth pixels is expected to improve the data efficiency, but this may impact the reconstruction of the image at a later time.

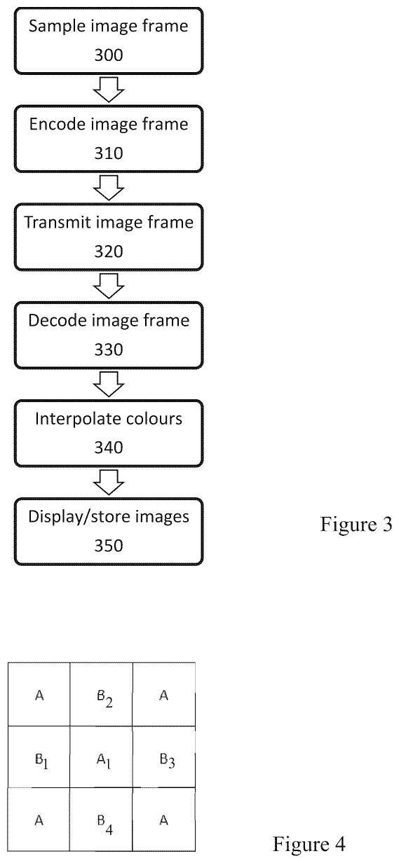

FIG. 3 schematically illustrates a method which utilises a colour sampling scheme in line with the discussion of FIG. 2. While described in the context of a single image frame, it is of course understood that the process may be applied to each of a plurality of image frames so as to generate video content. Alternatively, the encoding of the image frame may be in accordance with an image encoding format (rather than the video coding referenced below) so as to generate a single image for transmission.

A step 300 comprises sampling the pixel colours in an image frame in accordance with a predetermined pattern (such as a checkerboard) that indicates which pixels are to be sampled with a higher bit depth and which with a lower bit depth. As described above, each of a plurality of consecutive image frames may be sampled with a different predetermined pattern, such as by using an alternating checkerboard pattern between consecutive frames. The image frame may be from a video which is to be displayed, or may be the output of a video game or the like.

This sampling comprises reducing the bit depth of at least some of the pixels in the image frame; for instance, the source image may comprise colours with a bit depth of 16 bits with some pixels being sampled with 8 bits. Similarly, some pixels may be sampled with 12 bits while the remainder are sampled with 8 bits in the case that all pixels are to be sampled at a lower bit depth.

This sampling may be performed in any suitable manner. In some instances a compression of the colour values may be performed based on the relative ranges such that a value of 2048 in a 12-bit representation is mapped to 128 in an 8-bit representation. This preserves the relative value of the pixel colour component with respect to the range of possible values.

While that approach is computationally efficient, the result may not be of a particularly high quality due to the differences between the colour spaces not necessarily being linear and not necessarily being consistent between the different colour components. In such cases, it may instead be preferable to use an alternative approach to sampling.

One such example is to use a tonemapper to generate a colour value for a pixel having a reduced bit depth. This is a process which maps between the appearances of colours, rather than a linear mapping of pixel colour component values. In other words, a particular pixel colour is mapped to a similar colour within the reduced colour gamut. This tonemapping may be performed using any preferred algorithm, with the aim being to generate a colour which is perceptually similar in an efficient manner.

A step 310 comprises encoding the image frame comprising the sampled colour information; this may be performed in accordance with any suitable video codec.

A step 320 comprises transmitting the encoded image frame to a receiving device which is configured to output or store images. The transmission may be via any appropriate network, such as transmitting via the internet between a content streaming server and a viewing client, or streaming from a games console to a mobile device.

A step 330 comprises decoding the image frame at the device which receives the transmitted encoded image frame. This is performed in accordance with the video codec which is used to encode the image frame in step 310.

A step 340 comprises performing an interpolation process to generate an output image from the decoded image frame. This interpolation is performed to generate a new colour value for those pixels which were sampled at the lower bit depth. The pixels to have their values updated by the interpolation process may be identified through reference to the predetermined pattern used to sample the image frame (for instance, if this is communicated with the encoded image frame); alternatively, analysis of the decoded image frame may be performed to identify those pixels having a reduced bit depth as candidates for the interpolation process.

The specific weightings to be used for the interpolation may be selected freely to achieve a desired result, and may differ between pixels of the same image frame. Interpolation may be performed on a per-colour-component basis, in some instances, or each of the colour components may be interpolated simultaneously. While discussed below in the context of referencing only immediately adjacent pixels, in some cases it may be preferred to sample from more distant pixels (particularly in the case that a pattern other than a checkerboard or alternating rows/columns is used, as the amount of information able to be obtained from adjacent pixels may be reduced in such cases).

Taking FIG. 4 as an example in which the ‘A’ pixels have a reduced bit depth relative to the ‘B’ pixels, one suitable interpolation may be:

$${A}_{1}^{*} = \frac{4 {A}_{1} + {B}_{1} + {B}_{2} + {B}_{3} + {B}_{4}}{8}$$

Where A₁* represents the interpolated pixel colour for the pixel A₁. This provides an interpolation in which the low bit depth colour is weighted heavily against the surrounding high bit depth colours. This may be advantageous in the case that there is a sharp colour change within an image, and that the ‘A’ pixel does not match some or all of the surrounding ‘B’ pixels.

$${A}_{1}^{*} = \frac{{A}_{1} + {B}_{1} + {B}_{3}}{3}$$

This exemplary interpolation is an example in which the low bit depth colour is weighted equally against the surrounding high bit depth colours, but in which only the horizontally adjacent pixels are considered. This may be computationally more efficient, due to fewer processing operations being required, and in a number of cases may provide a comparable result.

As noted above, any suitable interpolation process may be performed, with the selection of a particular interpolation process being dependent upon processing efficiency, interpolation accuracy, and information about the content of the images. In respect of the last of these, it is noted that in some content it may be determined that considering the vertically-adjacent or horizontally-adjacent pixels will provide a comparable result due to information about the most common edge directions or the other typical properties of output images. This may be based upon previously-observed content from the same source, for instance.

$${A}_{1}^{*} = \frac{3 {A}_{1} + 2 ( {B}_{1} + {B}_{3} ) + ( {B}_{2} + {B}_{4} )}{6}$$

This provides a further example of an interpolation in which each of the surrounding pixels is considered, but not in equal proportions. The discussion of these interpolations is not considered to be exhaustive, but instead illustrative of the factors that may be considered when determining an appropriate interpolation to be used. The specific interpolation process that is selected may also be dependent upon a similarity between the respective pixel colours—in the case that any of the pixels has a significantly different colour to others, the interpolation may be adapted to reduce the influence of that pixel (or increase it, if it is the ‘A’ pixel in this example). This can assist in the reduction of blurry edges, as such differences are typically associated with a sharp edge in an image.

In some implementations an inverse tonemapping may be applied to the colour information for a pixel prior to the interpolating; this may improve the results of the interpolation by causing the initial pixel information to have already approximated the correct colour. However, this may be undesirable as this would introduce a processing burden in performing the inverse tonemapping- and so in some cases it may be preferable to skip this step. In some cases the interpolation process may be built into the inverse tonemapping such that a single-step process of converting a low bit depth pixel colour value to a high bit one is provided.

Other sources of data may also be considered when seeking to improve the accuracy of the interpolation. For instance, information about a scene or image as a whole may be utilised-such as the presence of particular objects or lighting within an image, edge information for an image frame, and/or histograms which provide additional detail. Similarly, information about the source content may be used-such as information about the preferred colour palette or the like. These may be used to select a particular interpolation process, in some cases; alternatively, or in addition, these may be used to verify and/or fine-tune an interpolation result.

In the case that multiple consecutive image frames are available at the decoder, an interpolation process may also (or instead) reference those image frames in generating the updated pixel colour value. This may be particularly suitable in the case in which the per-frame alternating checkerboard patterns are used, as the previous/following consecutive frames will comprise high bit depth colour information for that pixel without the need for interpolation.

A step 350 comprises displaying and/or storing the generated image; that is, the decoded image that has been subjected to the interpolation process so as to generate an image in which each of the pixels uses the same high bit depth colour representation.

Such a process may be advantageous compared to traditional methods for converting SDR content to HDR content (or otherwise increasing the bit depth) in that the accuracy is improved by using the predetermined pattern of pixels to enable an effective interpolation. As such, fewer errors in pixel values are encountered, and artefacts such as blurry edges can be reduced in the output image.

While the above method is discussed in the context of an entire image frame being subjected to the colour sampling process, it is also considered that the colour sampling may be performed on a per-region basis within an image frame. In other words, a portion of the image frame less than the entire image frame may be subjected to the colour sampling process. It is also considered that multiple regions may be defined, and that each of these may be associated with a different bit depth for the colour sampling that is applied. For example, in an image frame having a bit depth of 12 bits some areas may be sampled down to 10 bits and others to 8 bits as their respective bit depths. Such an approach can enable a tailoring of the balance between data efficiency and accuracy of reproduction.

In such cases, the regions of the image may be determined in any suitable manner. For example, regions may be defined in accordance with a foveal rendering process such that in the foveal region no colour sampling is performed while one or more regions outside of the foveal region are subjected to this process. Alternatively, or in addition, regions may be defined based upon the identification of salient regions within an image frame-such as objects expected to be of interest (based upon context or user preferences), or regions which are typically viewed by users (based upon tracked data of other users who have previously interacted with the content).

This process may be implemented on each image frame that is to be output by a system, such that a consistent efficiency improvement is observed. Alternatively, this process may be implemented in a more dynamic fashion. For example, the process may be ‘switched on’ when network bandwidth is below a threshold value, or for certain scenes-such as when motion within a scene is below a threshold value (as determined from motion vectors, for instance). These are examples of factors which indicate a need for improved efficiency and a reduced need for precise colour reproduction (as users are less likely to notice colours clearly when an object is moving quickly).

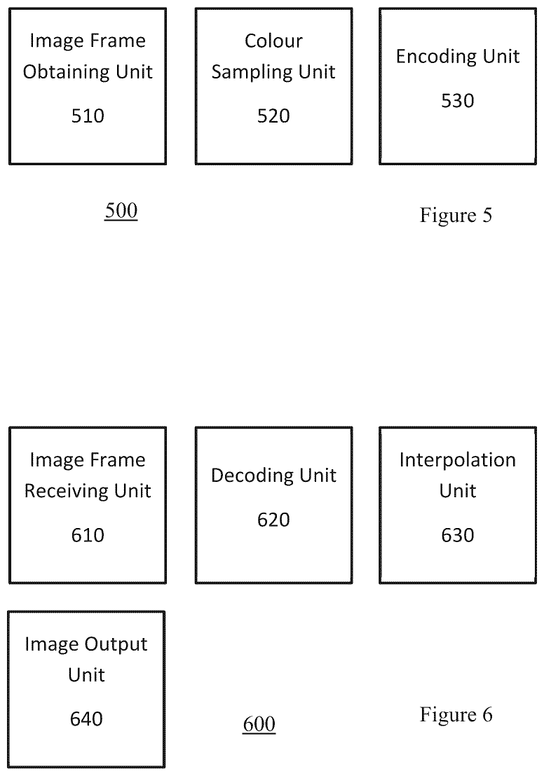

FIG. 5 schematically illustrates a system 500 for encoding video content. The system 500 comprises an image frame obtaining unit 510, a colour sampling unit 520, and an encoding unit 530. The system 500 may be embodied by a content distribution server, for instance, or any other device capable of outputting media content (such as the entertainment system of FIG. 1). Each of the functional units described may be implemented by any combination of CPUs and/or GPUs as appropriate.

The image frame obtaining unit 510 is configured to obtain one or more image frames from a content source; this content source may be a video file, for instance, or a video game. While individual image frames may be subjected to the processing described, the discussion of FIG. 5 will focus upon the encoding of a plurality of image frames which form a video sequence.

The colour sampling unit 520 is configured to sample a plurality of pixels within an obtained image frame in accordance with a predetermined pattern, wherein the predetermined pattern indicates a bit depth at which the colour of each of the pixels is to be sampled, wherein the colour sampling unit is configured to reduce the bit depth of at least a subset of the pixels within the obtained image frame. As one example, the obtained one or more image frames may comprise Wide Colour Gamut pixels, with the colour sampling unit 520 being configured to sample these to generate Standard Dynamic Range pixels.

In some implementations the predetermined pattern may be a checkerboard pattern, but other patterns may be selected freely as described above. The predetermined pattern may vary between different frames of the one or more frames. For example, two checkerboard patterns may be used (one being the inverse of the other) for consecutive image frames in a video sequence. Similarly, in the case that the predetermined pattern is tailored to specific content (such as a foveal rendering style implementation, or a saliency-based approach) the predetermined pattern may vary with the changes in the displayed content based upon the user's gaze direction or the location of objects within an image, for example.

In some cases, the predetermined pattern comprises a first region and a second region each corresponding to a plurality of pixels, the first region indicating a higher average bit depth per pixel than the second region, wherein the first region is identified in dependence upon a predicted or measured viewer gaze direction for the corresponding image frame. In other words, those parts of an image which are considered to be more likely to be viewed by a user or to be of greater interest may be encoded such that little or no sampling of the colours is performed in those parts of the image. Similarly, any parts of an image which are considered to be important for rendering with high accuracy may be exempted from the colour sampling process (or subjected to a reduced sampling, such that a higher bit depth is maintained for those parts of the image).

The predetermined pattern may also be determined on the basis of one or more image properties—for instance, retaining a higher proportion of high bit depth pixels near edges within the image. Alternatively, or in addition, an image may be analysed to identify blocks of uniform (or near-uniform, such as areas having a below threshold spatial frequency) colour, with these blocks having a reduced proportion of lower bit depth pixels.

The colour sampling unit 520 may be configured to sample each of the pixels within an image frame to a reduced bit depth, wherein the reduced bit depth is different for different pixels in accordance with the predetermined pattern. In other words, the entire image frame may be subjected to the colour sampling process but to different degrees in different areas. For instance, a 16 bit depth image may be sampled to 12 and 8 bit depths in respective image regions (and later interpolated to achieve a uniform 12 bit depth, for example).

As a part of the sampling process, the colour sampling unit 520 may be configured to perform a tonemapping process. The tonemapping is used to sample the high bit depth colours in a manner that approximates the colour with a reduced bit depth; this is in contrast to an approach in which the colour component values are mapped to lower bit depths in a more linear fashion.

The encoding unit 530 is configured to encode the one or more image frames that have been subjected to the colour sampling. This may be performed in accordance with any suitable image or video codec as desired for the given content. In some implementations the encoding unit 530 is also configured to encode additional data with the image frames (either alongside the image frames or as a separate data stream) that can include any information about one or more of the obtained image frames, the information comprising one or more of edge information, lighting information, content information, and/or one or more colour histograms. This is information that may be advantageous when used as a part of a corresponding interpolation process to be performed when decoding the image frames.

The arrangement of FIG. 5 is an example of a processor (for example, a GPU and/or CPU located in a games console or any other computing device) that is operable to encode video content, and in particular is operable to:
obtain one or more image frames from a content source;
   sample a plurality of pixels within an obtained image frame in accordance with a predetermined pattern, wherein the predetermined pattern indicates a bit depth at which the colour of each of the pixels is to be sampled, wherein the colour sampling unit is configured to reduce the bit depth of at least a subset of the pixels within the obtained image frame; and
   encode the one or more image frames that have been subjected to the colour sampling.

FIG. 6 schematically illustrates a system 600 for decoding video content, with this system being a counterpart to the system 500 of FIG. 5. The system 600 comprises an image frame receiving unit 610, a decoding unit 620, an interpolation unit 630, and an image output unit 640. This system 600 may be embodied by any suitable hardware, such as a games console, mobile phone, personal computer, or television. In some implementations, an entertainment system in accordance with FIG. 1 may provide the functionality of the system of FIG. 6 using the CPU and/or GPU as appropriate.

The image frame receiving unit 610 is configured to receive image frames encoded by a system 500 as described with reference to FIG. 5. The image frames may be received via any suitable network connection, such as the internet or a local connection.

The decoding unit 620 is configured to decode the received image frames to obtain one or more decoded image frames. This is performed in accordance with the codec selected by the encoding unit 530 of FIG. 5.

The interpolation unit 630 is configured to perform an interpolation process for pixels in the one or more decoded image frames which have a reduced bit depth, wherein the interpolation process generates colour values having an increased bit depth for those pixels. Such a process is described with reference to step 340 of FIG. 3, which notes that the specific form of the interpolation may be selected freely with respect to which pixels are referenced and their respective weightings. This process is configured to generate higher bit depth colour for pixels than is present in the decoded image frames, by leveraging information from nearby pixels (adjacent or further afield) which already have higher bit depth colour information.

In some implementations, the interpolation unit 630 may be configured to perform an interpolation process which uses one or more preceding or following image frames in a sequence to perform interpolation for a given image frame. This may be particularly beneficial in the case in which different predetermined patterns are used for consecutive image frames in a video.

The interpolation unit 630 may be configured to perform an inverse tonemapping process before interpolating pixel colour values, so as to generate colour information having a higher bit depth before refining it through an interpolation process.

The image output unit 640 is configured to output one or more image frames that have been subjected to the interpolation process; this may be an output for display, or to a storage device for later use.

The arrangement of FIG. 6 is an example of a processor (for example, a GPU and/or CPU located in a games console or any other computing device) that is operable to decode video content, and in particular is operable to:
receive image frames encoded by a system according to FIG. 5;
   decode the received image frames to obtain one or more decoded image frames;
   perform an interpolation process for pixels in the one or more decoded image frames which have a reduced bit depth, wherein the interpolation process generates colour values having an increased bit depth for those pixels; and
   output one or more image frames that have been subjected to the interpolation process.

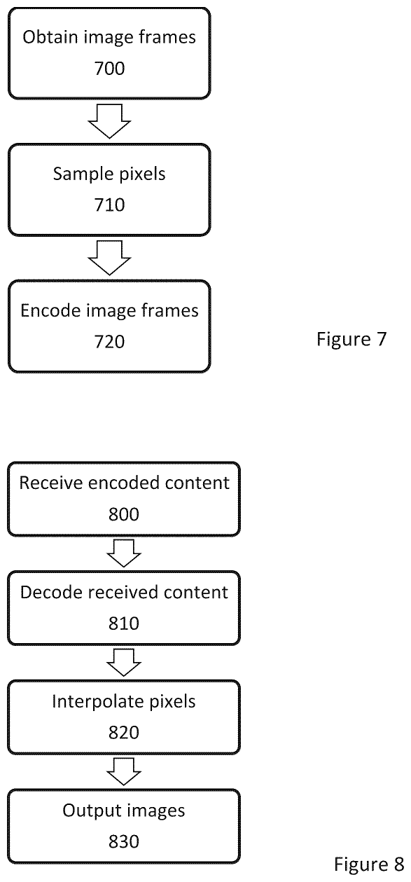

FIG. 7 schematically illustrates a method for encoding video content. This method may be implemented by the system 500 of FIG. 5, and in accordance with the steps 300 and 310 of FIG. 3 where appropriate.

A step 700 comprises obtaining one or more image frames from a content source.

A step 710 comprises sampling a plurality of pixels within an obtained image frame in accordance with a predetermined pattern, wherein the predetermined pattern indicates a bit depth at which the colour of each of the pixels is to be sampled, wherein the colour sampling reduces the bit depth of at least a subset of the pixels within the obtained image frame.

A step 720 comprises encoding the one or more image frames that have been subjected to the colour sampling.

FIG. 8 schematically illustrates a method for decoding video content. This method may be implemented by the system 600 of FIG. 6, and in accordance with the steps 330, 340, and 350 of FIG. 3 where appropriate.

A step 800 comprises receiving image frames encoded by a method according to FIG. 7.

A step 810 comprises decoding the received image frames to obtain one or more decoded image frames.

A step 820 comprises interpolating pixels in the one or more decoded image frames which have a reduced bit depth, wherein the interpolation generates colour values having an increased bit depth for those pixels.

A step 830 comprises outputting one or more image frames that have been subjected to the interpolation process.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A system for encoding video content, the system comprising:
an image frame obtaining unit configured to obtain one or more image frames from a content source;
a colour sampling unit configured to sample a plurality of pixels within an obtained image frame in accordance with a predetermined pattern, wherein the predetermined pattern indicates a bit depth at which the colour of each of the pixels is to be sampled, wherein the colour sampling unit is configured to reduce the bit depth of at least a subset of the pixels within the obtained image frame; and
an encoding unit configured to encode the one or more image frames that have been subjected to the colour sampling.

2. The system of claim 1, wherein the predetermined pattern is a checkerboard pattern.

3. The system of claim 1, wherein the predetermined pattern varies between different frames of the one or more image frames.

4. The system of claim 1, wherein the colour sampling unit is configured to sample each of the pixels within an image frame to a reduced bit depth, wherein the reduced bit depth is different for different pixels in accordance with the predetermined pattern.

5. The system of claim 1, wherein the predetermined pattern comprises a first region and a second region each corresponding to a plurality of pixels, the first region indicating a higher average bit depth per pixel than the second region, wherein the first region is identified in dependence upon a predicted or measured viewer gaze direction for a corresponding image frame.

6. The system of claim 1, wherein the one or more image frames comprise Wide Colour Gamut pixels, and the colour sampling unit is configured to sample these to generate Standard Dynamic Range pixels.

7. The system of claim 1, wherein the colour sampling unit is configured to perform a tonemapping process as a part of the sampling.

8. The system of claim 1 wherein:
the image frame obtaining unit is configured to obtain information about one or more of the image frames;
the information comprising one or more of edge information, lighting information, content information, and/or one or more colour histograms; and
the encoding unit is configured to encode the information with the image frames.

9. A method for encoding video content comprising:
obtaining one or more image frames from a content source;
sampling a plurality of pixels within an obtained image frame in accordance with a predetermined pattern, wherein the predetermined pattern indicates a bit depth at which a colour of each of the pixels is to be sampled, wherein the colour sampling reduces the bit depth of at least a subset of the pixels within the obtained image frame; and
encoding the one or more image frames that have been subjected to the colour sampling.

10. The method of claim 9, wherein the predetermined pattern is a checkerboard pattern.

11. The method of claim 9, wherein the predetermined pattern varies between different frames of the one or more image frames.

12. The method of claim 9, wherein sampling the plurality of pixels comprises sampling each of the pixels within an image frame to a reduced bit depth, wherein the reduced bit depth is different for different pixels in accordance with the predetermined pattern.

13. The method of claim 9, wherein the predetermined pattern comprises a first region and a second region each corresponding to a plurality of pixels, the first region indicating a higher average bit depth per pixel than the second region, wherein the first region is identified in dependence upon a predicted or measured viewer gaze direction for a corresponding image frame.

14. The method of claim 9, wherein the one or more image frames comprise Wide Colour Gamut pixels, and wherein sampling the plurality of pixels comprises sampling the Wide Colour Gamut pixels to generate Standard Dynamic Range pixels.

15. The method of claim 9, wherein sampling the plurality of pixels comprises performing a tonemapping process as a part of the sampling.

16. The method of claim 9, further comprising:
obtaining information about one or more of the image frames, wherein the information comprises one or more of edge information, lighting information, content information, and/or one or more colour histograms; and
encoding the information with the image frames.

17. A non-transitory computer-readable medium storing instructions that, when executed by one or more processors, cause the one or more processors to perform operations comprising:
obtain one or more image frames from a content source;
sample a plurality of pixels within an obtained image frame in accordance with a predetermined pattern, wherein the predetermined pattern indicates a bit depth at which a colour of each of the pixels is to be sampled, wherein the colour sampling reduces the bit depth of at least a subset of the pixels within the obtained image frame; and
encode the one or more image frames that have been subjected to the colour sampling.

18. The non-transitory computer-readable medium of claim 17, wherein the predetermined pattern is a checkerboard pattern.

19. The non-transitory computer-readable medium of claim 17, wherein the predetermined pattern varies between different frames of the one or more image frames.

20. The non-transitory computer-readable medium of claim 17, wherein sampling the plurality of pixels comprises sampling each of the pixels within an image frame to a reduced bit depth, wherein the reduced bit depth is different for different pixels in accordance with the predetermined pattern.
